(19) United States
(12) Patent Application Publication
(10) Pub. No.: US 2017/0016231 A1
(43) Pub. Date: Jan. 19, 2017

(54) COMPACT ANCHOR FOR POST-TENSIONED CONCRETE SEGMENT

(71) Applicant: Felix Sorkin, Stafford, TX (US)

(72) Inventor: Felix Sorkin, Stafford, TX (US)

(21) Appl. No.: 15/212,629

(22) Filed: Jul. 18, 2016

Related U.S. Application Data
(60) Provisional application No. 62/338,112, filed on May 18, 2016.
(60) Provisional application No. 62/200,994, filed on Aug. 4, 2015.
(60) Provisional application No. 62/193,866, filed on Jul. 17, 2015.
(60) Provisional application No. 62/193,883, filed on Jul. 17, 2015.
(60) Provisional application No. 62/193,898, filed on Jul. 17, 2015.

(51) Int. Cl. E04C 5/12; B28B 11/24; B28B 1/14; B28B 23/04

(52) U.S. Cl. CPC E04C 5/122; B28B 23/043; B28B 11/243; B28B 1/14

(57) ABSTRACT

An anchor assembly for a post-tensioning tendon may include a compact anchor and wedge. The compact anchor may include a wedge extension having a frustoconical inner surface. The frustoconical inner surface may have a diameter of 0.95 inches or less. The compact wedge may have a length of 1.1 inches or less. The compact anchor and compact wedge may be formed from steel having no added lead. The compact anchor and wedge may be formed by cold heading.

### CROSS-REFERENCE TO RELATED APPLICATIONS

This application is a nonprovisional application that claims priority from U.S. provisional application No. 62/338,112, filed May 18, 2016, which is hereby incorporated by reference in its entirety. This application also claims priority from U.S. provisional application No. 62/200,994, filed Aug. 4, 2015, which is hereby incorporated by reference in its entirety. This application also claims priority from U.S. provisional application No. 62/193,866, filed Jul. 17, 2015, which is hereby incorporated by reference in its entirety. This application also claims priority from U.S. provisional application No. 62/193,883, filed Jul. 17, 2015, which is hereby incorporated by reference in its entirety. This application also claims priority from U.S. provisional application No. 62/193,898, filed Jul. 17, 2015, which is hereby incorporated by reference in its entirety.

### TECHNICAL FIELD/FIELD OF THE DISCLOSURE

The present disclosure relates to post-tension anchorage systems. More particularly, the present disclosure relates to anchors used in post-tension anchorage systems.

### BACKGROUND OF THE DISCLOSURE

Many structures are built using concrete, including, for instance, buildings, parking structures, apartments, condominiums, hotels, mixed-use structures, casinos, hospitals, medical buildings, government buildings, research/academic institutions, industrial buildings, malls, roads, bridges, pavement, tanks, reservoirs, silos, sports courts, and other structures.

Prestressed concrete is structural concrete in which internal stresses are introduced to reduce potential tensile stresses in the concrete resulting from applied loads; prestressing may be accomplished by post-tensioned prestressing or pre-tensioned prestressing. In post-tensioned prestressing, a tension member is tensioned after the concrete has attained a desired strength by use of a post-tensioning tendon. The post-tensioning tendon may include for example and without limitation, anchor assemblies, the tension member, and sheathes. Traditionally, a tension member is constructed of a material that can be elongated and may be a single or a multi-strand cable. Typically, the tension member may be formed from a metal or composite material, such as reinforced steel. The post-tensioning tendon conventionally includes an anchor assembly at each end. The post-tensioning tendon is fixedly coupled to a fixed anchor assembly positioned at one end of the post-tensioning tendon, the “fixed-end”, and stressed at the stressed anchor assembly positioned at the opposite end of the post-tensioning tendon, the “stressing-end” of the post-tensioning tendon.

Typically, the fixed anchor assembly and the stressed anchor assembly include an anchor and one or more wedges that are used to secure the tension member thereto. Conventionally, the anchors and wedges are formed as castings. The conventional anchors and wedges are formed by casting a mixture of lead and steel. However, casting introduces imperfections in the anchors and wedges such as pores, shrinkage defects, misruns, cold shuts, inclusions, and other metallurgical defects. These imperfections reduce the strength of the anchors and wedges, and the anchors and wedges are conventionally manufactured with an excess of material, thereby forming a larger wedge and/or anchor than would be required but for the imperfections. The inclusion of lead in the steel also reduces the strength of the anchors and wedges produced by the casting process. For anchors and wedges using in post-tensioning, conventional anchors have a diameter of at least one inch and conventional wedges have a length of at least 1.2 inches.

The concrete may be poured into a concrete form. The concrete form may be a form or mold into which concrete is poured or otherwise introduced to give shape to the concrete as it sets or hardens thus forming a concrete segment. Typically, prestressing is utilized for large or expensive installations such as bridges, whereas smaller concrete members such as slabs and roadways are constructed with reinforced and not prestressed concrete. Reinforced concrete may be poured about a metal support structure such as rebar. Rebar may be less expensive than existing post-tensioning tendons which are typically designed to handle the encountered stresses of larger installations. Because the components of the existing post-tensioning tendons are designed to handle higher forces than are encountered in smaller concrete members, they are more expensive to manufacture and are designed to far exceed expected structural loading.

### SUMMARY

The present disclosure provides an anchor assembly for a post-tensioned concrete segment. The anchor assembly includes a compact anchor, the compact anchor including a wedge extension having a frustoconical inner surface, the frustroconical inner surface having an inner diameter. The compact anchor is formed from steel having no lead. The anchor assembly also includes a compact wedge, the compact wedge formed from steel having no lead.

The present disclosure also provides for a concrete segment for one or more of houses, parking structures, apartments, condominiums, hotels, mixed-use structures, casinos, hospitals, medical buildings, government buildings, research/academic institutions, industrial buildings, malls, pavement, tanks, reservoirs, silos, roads, bridges, or sports courts, the concrete segment formed from concrete and having one or more post-tensioning tendons positioned therein. Each post-tensioning tendon includes a stressing end anchor assembly, the stressing end anchor assembly including a first compact anchor and compact wedge. The first compact anchor includes a first wedge extension having a first frustoconical inner surface, the first frustoconical inner surface having an inner diameter. Each post-tensioning tendon also includes a fixed end anchor assembly including a second compact anchor and compact wedge. The second compact anchor includes a second wedge extension having a second frustoconical inner surface, the second frustoconical inner surface having an inner diameter. Each post-tensioning tendon further includes a tension member, the tension member extending from the fixed end anchor assembly to the stressing end anchor assembly.

The present disclosure also provides for a method. The method includes providing a concrete form, the concrete form formed in the desired final shape of at least part of a concrete segment. In addition, the method includes positioning one or more post-tensioning tendons in the concrete form. Each post-tensioning tendon includes a stressing end anchor assembly, the stressing end anchor assembly including a first compact anchor and compact wedge. The first compact anchor includes a first wedge extension having a first frustoconical inner surface, the first frustoconical inner surface having an inner diameter of 0.95 inches or less, and the first compact wedge having a length of 1.1 inches or less. Each post-tensioning tendon also includes a fixed end anchor assembly including a second compact anchor and compact wedge, the second compact anchor including a second wedge extension having a second frustoconical inner surface, the second frustoconical inner surface having an inner diameter of 0.95 inches or less, and the second compact wedge having a length of 1.1 inches or less. Each post-tensioning tendon also includes a tension member, the tension member extending from the fixed end anchor assembly to the stressing end anchor assembly. The method additionally includes placing concrete into the concrete form and tensioning the tension member.

### BRIEF DESCRIPTION OF THE DRAWINGS

The present disclosure is best understood from the following detailed description and the accompanying figures. Various features are not drawn to scale. The dimensions of the various features may be arbitrarily increased or reduced for clarity of discussion.

FIG. 1 depicts a partially transparent perspective view of a concrete segment having a post-tensioned tendon consistent with at least one embodiment of the present disclosure.

FIGS. 2A-2B depict partial cross section views of an anchor assembly in the concrete segment of FIG. 1.

FIG. 3A is a perspective view of a compact anchor and wedge consistent with at least one embodiment of the present disclosure.

FIG. 3B is a front-view of a compact anchor consistent with at least one embodiment of the present disclosure.

FIG. 3C is a cross-section view of a compact anchor consistent with at least one embodiment of the present disclosure.

FIG. 4 is a block diagram of a cold heading apparatus for a manufacturing a compact wedge consistent with at least one embodiment of the present disclosure.

FIG. 5 is a side view of compact wedges consistent with at least one embodiment of the present disclosure.

### DETAILED DESCRIPTION

The following disclosure provides many different embodiments, or examples, for implementing different features of various embodiments. Specific examples of components and arrangements are described below to simplify the present disclosure. These are examples and are not intended to be limiting. In addition, the present disclosure may repeat reference numerals or letters in the various examples. This repetition is for the purpose of simplicity and clarity and does not in itself dictate a relationship between the various embodiments or configurations discussed.

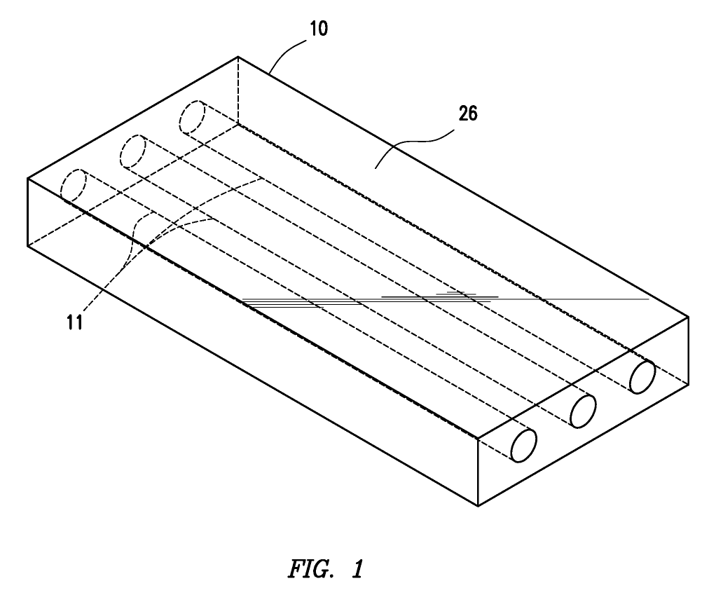

FIG. 1 depicts a partially transparent perspective view of concrete segment 10. Concrete segment 10 may be used as a foundation for a building such as, for example and without limitation, one or more of houses, parking structures, apartments, condominiums, hotels, mixed-use structures, casinos, hospitals, medical buildings, government buildings, research/academic institutions, industrial buildings, malls, pavement, tanks, reservoirs, silos, sports courts, or other structures. Concrete segment 10 may also be used in the construction of a road or a bridge.

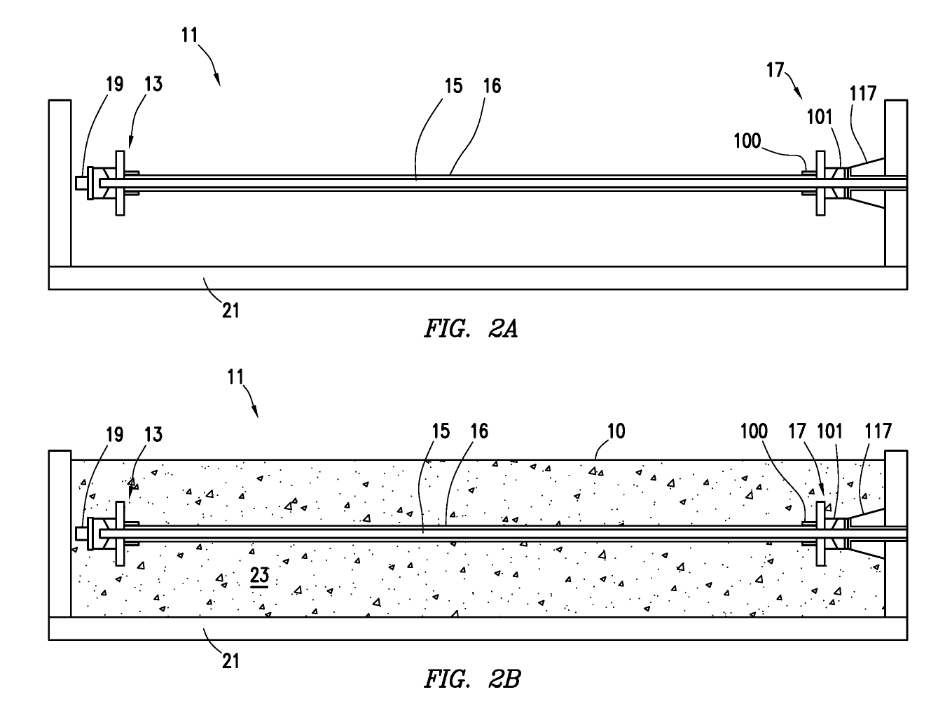

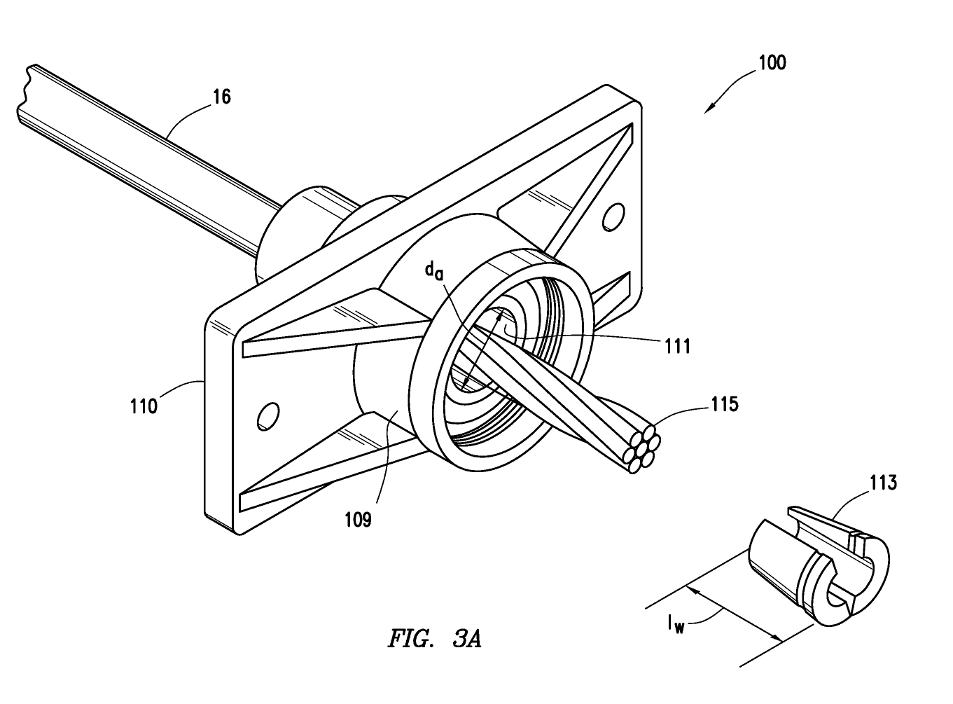

Concrete segment 10 may be formed from concrete 26. Concrete segment 10 may include one or more post-tensioning tendons 11 formed therein. Post-tensioning tendons 11, as depicted in FIGS. 2A, 2B may include, for example and without limitation, fixed end anchor assembly 13, tension member 15, and stressing end anchor assembly 17. Tension member 15 may extend between fixed end anchor assembly 13 positioned at a first position within concrete form 21 and stressing end anchor assembly 17 positioned at a second position within concrete form 21 as further discussed hereinbelow. In some embodiments, post-tensioning tendon 11 may also include sheath 16 positioned about tension member 15 and one or more seals (not shown) between sheath 16 and each anchor 13, 17. Sheath 16 and seals may, for example, protect tension member 15 from corrosion after concrete 23 is poured, as shown in FIG. 2B. Additionally, sheath 16 and seals may, for example, reduce or prevent concrete from ingressing into tension member 15 and preventing or retarding tensioning of tension member 15 as discussed below. In some embodiments, a seal for fixed end anchor assembly 13 may be omitted.

As depicted in FIG. 2A, in some embodiments, fixed end anchor assembly 13 may be positioned within concrete form 21 such that fixed end anchor assembly 13 may be encased in concrete 23. In some embodiments, fixed end cap 19 may be coupled to fixed end anchor assembly 13 to protect tension member 15 from corrosion after concrete 23 is poured.

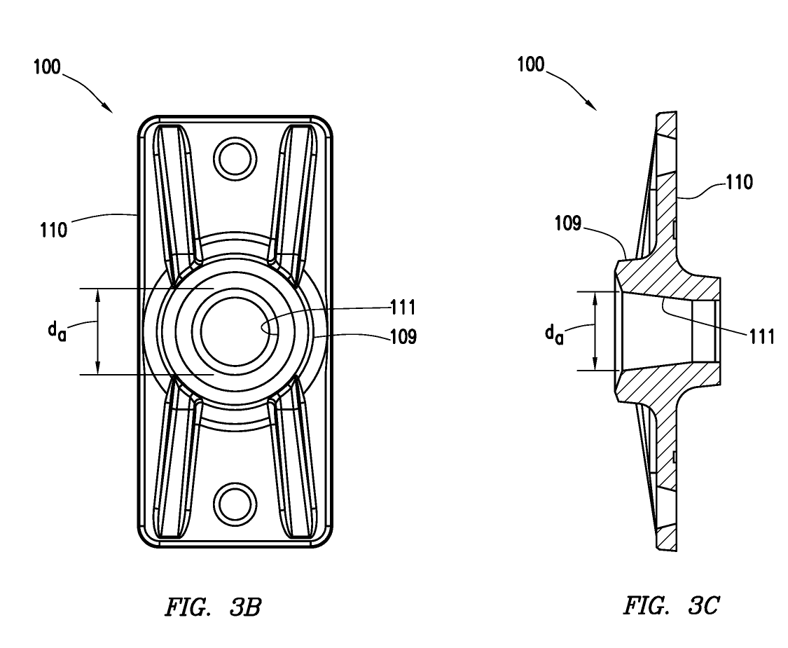

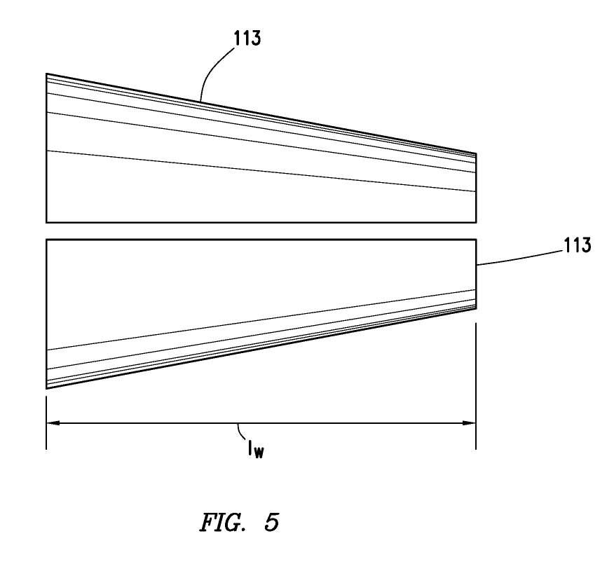

In some embodiments, each of anchor assemblies 13, 17 may include compact anchor 100, referred to herein as first compact anchor for stressing end anchor assembly 17 and second compact anchor for fixed end anchor assembly 13. In some embodiments, as depicted in FIGS. 3A-C, compact anchor 100 may include anchor plate 110. Anchor plate 110 may, in some embodiments, be a flat portion of compact anchor 100. Anchor plate 110 may allow for a compressive force to be applied to concrete 23 after post-tensioning tendon 11 is tensioned as discussed herein below. In some embodiments, compact anchor 100 may include wedge extension 109. Wedge extension 109 may be an annular projection extending from a face of anchor plate 110 of compact anchor 100. Wedge extension 109 may have a frustoconical inner surface 111 for receiving one or more compact wedges 113 that engage tension member 15 when tension member 15 is tensioned. As used herein, the combination of one or more compact wedges 113 and compact anchor 100 is defined as an “anchor assembly.” In some embodiments, inner diameter da of frustoconical inner surface 111 of wedge extension 109 of compact anchor 100 may be 0.95 inches or less or may be 0.9 inches or less. As used herein, the inner diameter of a frustoconical inner surface, such as inner diameter da of frustoconical inner surface 111, is measured at its widest point. In some embodiments, inner diameter da of frustoconical inner surface 111 of wedge extension 109 of compact anchor 100 may be 0.45 inches or less or may be 0.4 inches or less. In some embodiments, inner diameter da of frustoconical inner surface 111 of wedge extension 109 of compact anchor 100 may be 95% of the inner diameter of the frustroconical inner surface of wedge extensions of conventional anchors or may be 90% of the inner diameter the frustroconical inner surface of wedge extensions of conventional anchors. In some embodiments, length l_{w} of compact wedges 113, as depicted in FIGS. 3A and 5 may be 1.1 inches or less or may be 1 inch or less. In some embodiments, length l_{w} of compact wedges 113 may be 95% or less of the length of conventional wedges or may be 90% of the typical length of conventional wedges. By making compact anchor 100 and compact wedges 113 smaller than typical anchors and wedges, the cost of forming compact anchor 100 and compact wedges 113 may be reduced compared to typical anchors and wedges.

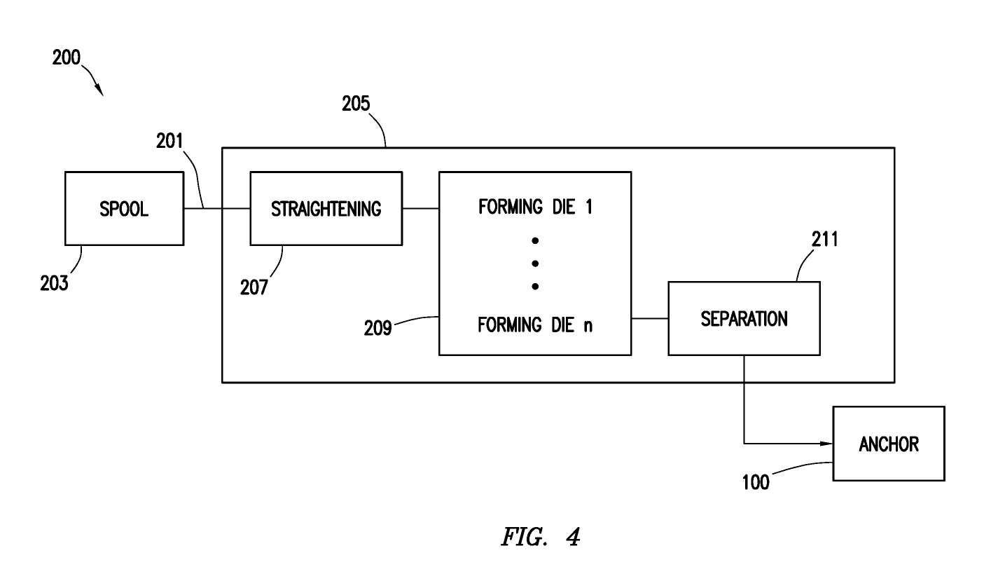

In some embodiments, compact anchor 100 and compact wedges 113 may be constructed from steel. In some embodiments, compact anchor 100 and compact wedges 113 may be formed by cold heading. Cold heading is a process in which compact anchor 100 and compact wedges 113 are formed by progressive deformation by a series of dies. FIG. 4 depicts a block diagram of cold heading apparatus 200. Wire 201 may be provided on spool 203. Wire 201 may be fed by one or more drive wheels (not shown) into cold heading apparatus 205. In some embodiments, cold heading apparatus 205 may include straightening apparatus 207, which may include a plurality of rollers adapted to straighten wire 201 as it enters cold heading apparatus 205. Wire 201 may be fed to forming dies 209. Forming dies 209 may reshape a portion of wire 201 progressively into the final form of one or more anchors 100. A portion of wire 201 is separated 211 from the rest of wire 201, separating the one or more formed compact anchors 100.

In some embodiments, because compact anchor 100 and compact wedges 113 are formed by cold heading and not by casting, compact anchor 100 and compact wedges 113 may be formed from steel with no lead or other additives, which may enhance castability and machinability of the part at the expense of material strength. Likewise, because compact anchor 100 and compact wedges 113 are formed by cold heading and not by casting, imperfections such as pores, shrinkage defects, misruns, cold shuts, inclusions, or metallurgical defects associated with the casting may be avoided, and more consistent material properties may be achieved. Compact anchor 100 and compact wedges 113 may have higher material strength and may thus be formed at a smaller size so as to not have to account for manufacturing defects from casting processes. Additionally, because compact anchor 100 and compact wedges 113 are smaller than conventional wedges, the additional strength of unleaded steel may allow the smaller wedges to handle higher stresses than would conventional anchors and wedges formed from leaded steel.

In some embodiments, as shown in FIGS. 2A, 2B, compact anchor 100 may include encapsulation 101. Encapsulation 101 may be formed from, for example and without limitation, polyethylene or high-density polyethylene.

In some embodiments, to post-tension concrete segment 10, post-tensioning tendon 11 may be positioned within concrete form 21. Concrete form 21 may, for example and without limitation, be formed in the desired final shape of part or all of concrete segment 10. Once post-tensioning tendon 11 is positioned in concrete form 21, concrete 23 may be placed into concrete form 21 as depicted in FIG. 1B. As concrete 23 is poured, fixed end anchor assembly 13, tension member 15, and stressing end anchor assembly 17 may remain in position within concrete 23 and may substantially surround these elements. Once set, concrete 23 may retain fixed end anchor assembly 13, tension member 15, and stressing end anchor assembly 17 in position. Tension member 15 may then be tensioned to place concrete segment 10 under compressive loading, understood in the art as post-tensioning. Once concrete segment 10 is post-tensioned, the structure to be built upon concrete segment 10 may be constructed.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. An anchor assembly for a post-tensioned concrete segment comprising:
a compact anchor, the compact anchor including a wedge extension having a frustoconical inner surface, the frustroconical inner surface having an inner diameter, the compact anchor formed from steel having no lead; and
a compact wedge, the compact wedge formed from steel having no lead.

2. The anchor assembly of claim 1, wherein the compact anchor is formed by cold heading.

3. The anchor assembly of claim 1, wherein the compact wedge is formed by cold heading.

4. The anchor assembly of claim 1, wherein the inner diameter of the frustoconical inner surface of the compact anchor is 0.95 inches or less.

5. The anchor assembly of claim 1, wherein the inner diameter of the frustoconical inner surface of the compact anchor is 0.45 inches or less.

6. The anchor assembly of claim 1, wherein the compact wedge has a length of 1.1 inches or less.

7. A concrete segment for one or more of houses, parking structures, apartments, condominiums, hotels, mixed-use structures, casinos, hospitals, medical buildings, government buildings, research/academic institutions, industrial buildings, malls, pavement, tanks, reservoirs, silos, roads, bridges, or sports courts, the concrete segment formed from concrete and having one or more post-tensioning tendons positioned therein, each post-tensioning tendon including:
a stressing end anchor assembly, the stressing end anchor assembly including a first compact anchor and compact wedge, the first compact anchor including a first wedge extension having a first frustoconical inner surface, the first frustoconical inner surface having an inner diameter;
a fixed end anchor assembly including a second compact anchor and compact wedge, the second compact anchor including a second wedge extension having a second frustoconical inner surface, the second frustoconical inner surface having an inner diameter; and
a tension member, the tension member extending from the fixed end anchor assembly to the stressing end anchor assembly.

8. The concrete segment of claim 7, wherein the compact anchors are formed from steel having no lead.

9. The concrete segment of claim 7, wherein the compact wedges are formed from steel having no lead.

10. The concrete segment of claim 7, wherein the compact anchors are formed by cold heading.

11. The concrete segment of claim 7, wherein the compact wedges are formed by cold heading.

12. The concrete segment of claim 7, wherein the frustoconical inner diameters of the compact anchors are 0.95 inches or less.

13. The concrete segment of claim 7, wherein the frustoconical inner diameters of the compact anchors are 0.95 inches or less.

14. The concrete segment of claim 7, wherein the compact wedges have a length of 1.1 inches or less.

15. A method comprising:
providing a concrete form, the concrete form formed in the desired final shape of at least part of a concrete segment;
positioning one or more post-tensioning tendons in the concrete form, each post-tensioning tendon including:
a stressing end anchor assembly, the stressing end anchor assembly including a first compact anchor and compact wedge, the first compact anchor including a first wedge extension having a first frustoconical inner surface, the first frustoconical inner surface having an inner diameter of 0.95 inches or less, the first compact wedge having a length of 1.1 inches or less;
a fixed end anchor assembly including a second compact anchor and compact wedge, the second compact anchor including a second wedge extension having a second frustoconical inner surface, the second frustoconical inner surface having an inner diameter of 0.95 inches or less, the second compact wedge having a length of 1.1 inches or less; and
a tension member, the tension member extending from the fixed end anchor assembly to the stressing end anchor assembly;
placing concrete into the concrete form; and
tensioning the tension member.

16. The method of claim 15, further comprising allowing the concrete to set to form a concrete segment.

17. The method of claim 16, further comprising constructing one or more of houses, parking structures, apartments, condominiums, hotels, mixed-use structures, casinos, hospitals, medical buildings, government buildings, research/academic institutions, industrial buildings, malls, pavement, tanks, reservoirs, silos, roads, bridges, or sports courts on the concrete segment.

18. The method of claim 15, wherein the compact anchor is formed from steel having no lead.

19. The method of claim 15, wherein the compact wedge is formed from steel having no lead.

20. The method of claim 15, wherein the compact anchor is formed by cold heading.

21. The method of claim 15, wherein the compact wedge is formed by cold heading.

22. The method of claim 15, wherein the diameter of the frustoconical inner surface of the compact anchor is 0.9 inches or less.

23. The method of claim 15, wherein the diameter of the frustoconical inner surface of the compact anchor is 0.45 inches or less.

24. The method of claim 15, further comprising setting the concrete to form a concrete segment.
